(19) United States
(12) Patent Application Publication
(10) Pub. No.: US 2010/0101085 A1
(43) Pub. Date: Apr. 29, 2010

(54) Method Of Manufacturing A Crankshaft And A Half-Finished Crankshaft

(75) Inventor: Tetsuo Miura, Fukushima (JP)

Correspondence Address: KILYK & BOWERSOX, P.L.L.C., 400 HOLIDAY COURT, SUITE 102, WARRENTON, VA, 20186, US

(73) Assignee: TECHNO-METAL CO., LTD., Fukushima (JP)

(21) Appl. No.: 12/648,036

(22) Filed: Dec. 28, 2009

Related U.S. Application Data
(63) Continuation of application No. PCT/JP2007/063627, filed on Jul. 3, 2007.

(51) Int. Cl. B23P 17/00

(52) U.S. Cl. 29/888.08

(57) ABSTRACT

To cope with requirements for strict accuracy of crankshafts while alleviating the task of controlling a forming process, a preliminary machining step (S117) is added before primary mass balance measurement (S118) prior to boring of center holes into opposite end surfaces of a crankshaft mold. In the preliminary machining step (S117), balance weight portions of the crankshaft mold are machined.

### CROSS-REFERENCE TO RELATED APPLICATIONS

The present application is a continuation application of PCT/JP2007/063627, filed Jul. 3, 2007, which is incorporated herein by reference in its entirety.

### FIELD OF THE INVENTION

The present invention relates to a crankshaft for use as an engine output shaft, and more particularly, to a method of manufacturing a crankshaft and a half-finished crankshaft.

### BACKGROUND OF THE INVENTION

Crankshafts for use as engine output shafts are roughly classified to cast crankshafts and forged crankshafts depending on the forming process. Cast crankshafts are mainly used in lower rotation type engines and small engines with relatively small engine torques. Forged crankshafts are used in high rotation type engines and large engines with relatively large torques because they have compact metallographic structure and can be improved in mechanical properties by adding heat treatment after forging, if desired.

Manufacturing of a crankshaft, either by casting or by forging, roughly includes a forming process for preparing a crankshaft mold, a machining process for machining the crankshaft mold into a finished form of the crankshaft, and a mass balance adjusting process for adjusting the mass balance of the crankshaft. As well known, there is a large difference in working environment between the forming process and the machining process.

The forming process uses a large thermal energy to heat and transform blanks for crankshafts (hereafter called crankshaft blanks) in form of lumbers of steel, and its working environment is exposed to a high temperature. Further, in case of forging, for example, vibration is produced by operation of a hammer-type forging machine (see Publication No. JP-H04-294240) or a press type forging machine (see Publication No. JP-H02-41730) in the forging process. In contrast, the machining process requires a clean and vibration-free environment to ensure high-precision machining. In addition, there is a large difference in basic technology between the forming process and the machining process.

Along with development of automobile industry, the manufacturing process of crankshafts has been divided and shared by different specialized engineering parties since an early age. An example of such process sharing in the manufacturing system of forged crankshafts is shown in FIG. 9. With reference to FIG. 9, crankshaft blanks carried into a forging factory are each introduced into a forging die and, after heated to about 1250° C., forged by hot forging using a press type or hammer type forging machine (forging step S11). A resulting crankshaft mold is removed from the forging machine and subjected to a trimming process for removing residual flash from its peripheral contour (S12). Further, any undesirable bending in the crankshaft molds, which is liable to occur in the trimming process, is cured in the next coining process S13. After the coining process S13, the crankshaft mold is cooled at a room temperature or in a cold air (S14). Subsequently, via heat treatment (S15), if necessary, the crankshaft mold undergoes shot blasting (S16). Through the series of steps S11-S16, a treated crankshaft mold ready to machine is obtained. These steps S11-S16 are carried out in the forging factory. The treated crankshaft mold is next delivered to a center hole boring or drilling factory, after or without flattening machining of its opposite end surfaces (S17), it is subjected to primary mass balance measurement (S18). In accordance with the primary mass balance measurement, center holes are bored or drilled (S19). The half-finished crankshaft having the center holes is shipped from the center hole boring factory toward a machining factory.

In the machining factory, machining (finish machining) is carried out by using the center holes as a reference, namely, a rotation center (S21). The finish machining includes machining of opposite side surfaces and outer circumferential surfaces of balance weight portions, machining (including polishing) of pin portions, machining (including polishing) of journal portions, and boring or drilling of oil passages. As a result of this finish machining, a half-finished crankshaft machined to a finished product size of the crankshaft is obtained.

The half-finished crankshaft after the finish machining is subjected to mass balance adjustment in the next step S22. The mass balance adjustment is carried out by measuring any unbalance of the crankshaft by mass balance measurement and locally reducing the weight of balance weight portions of the crankshaft, referring to the measured unbalance. The local weight reduction of the balance weight portions is typically effected by digging balance adjustment cavities into the outer circumferences of the balance weight portions. The crankshaft thus adjusted in balance by the mass balance adjustment is assembled in an engine as a finished crankshaft.

FIG. 10 illustrates a crankshaft for use in a four-cylinder engine. As known, the crankshaft 1 has journal portions 3 coaxially positioned with a rotation center line L regulated by center holes 2, 2 bored into the opposite end surfaces of the crankshaft 1, pin portions 5 offset from the rotation center line L by arm portions 4 extending in the radial direction, and balance weight portions 6 extending diametrically from the arm portions 4. Oil passages 7 are opened onto the journal portions 3 and the pin portions 5. The journal portions 3 will be rotatably supported by pivots on a cylinder block, not shown. The pin portions 5 are used to connect pistons (not shown) with connecting rods (not shown). With the crankshaft 1 assembled in the engine, reciprocal movement of the pistons is converted to rotational movement by the crankshaft 1. Reference numeral 8 in FIG. 10 denotes balance adjustment cavities dug into the balance weight portions 6 for final mass balance adjustment (S22 of FIG. 9).

A portion of a crankshaft mold prepared in a forging factory is roughly illustrated in FIG. 11. The crankshaft mold 10, either by casting or by forging, includes draft portions 11 to be machined away. The draft portions 11 are an amount of extra material placed on the mold to facilitate separation thereof from the die. In press forging, for example, the draft angle (θ) is normally set to 1 to 3°. In case of hammer forging, the draft angle (θ) is normally set to 6 to 7°. The difference in draft angle θ of the draft portions 11 is caused by a difference in mechanical property between the press forging machines and the hammer forging machines. That is, press forging machines can incorporate a device for pushing out the forgings, but hammer forging machines cannot. Therefore, forging by hammer forging machines requires a relatively large draft angle (6-7°) at the draft portions 11.

In manufacturing of crankshafts, mass balance adjustment (S22 of FIG. 9) carried out after machining the half-finished crankshaft up to a finished product size of the crankshaft assumes an important role. Besides, more and more accuracy is required for crankshafts along with developments toward higher qualities of engines. To cope with this requirement, production control in machining factories is getting harder and harder from year to year. Accordingly, for ready-to-machine crankshafts as well, strict control of product errors is required. In the existing techniques, reduction of production errors of ready-to-machine crankshaft relies upon the accuracy of the forging or casting machines. However, here is the problem that it is difficult to control and compensate abrasion of forging or casting dies by use.

### SUMMARY OF INVENTION

It is therefore an object of the present invention to provide a method of manufacturing a crankshaft and a half-finished crankshaft, which includes a forming process, a machining process and a mass balance adjustment process and alleviates the task of supervising or watching the forming process while satisfying the requirement of strict product accuracy of the crankshaft.

In the environment with increasingly strict requirement for product accuracy of crankshafts, engineers' efforts for enhancing the product accuracy of crankshafts by strictly controlling the forming process have already reached a limit, and such control becomes more and more costly with increased strictness. The Inventor has made the present invention from his own unique awareness that substantially no further progress will be expected if engineers' eyes stick to the forming process alone.

According to an aspect of the present invention to accomplish the above-mentioned object, there is provided a method of manufacturing a crankshaft comprising: a forming step for preparing a crankshaft mold in a die; a machining step for obtaining a crankshaft by machining the crankshaft mold to a finished product size of the crankshaft; and a mass balance adjustment step for adjusting the mass balance of the crankshaft, wherein the machining step includes: a preliminary machining step for machining balance weight portions of the crankshaft mold; a center hole boring step for boring center holes into the crankshaft mold already machined in the preliminary machining step in accordance with a result of mass balance measurement; and a finish machining step for finish machining the crankshaft mold to the finished product size of the crankshaft to complete the crankshaft by using the center holes as a reference, wherein machining of the preliminary machining step applied to the side surfaces of the balance weight portions is executed up to a finish product size or nearly finished product size of the crankshaft.

According to a further aspect of the present invention to accomplish the above-mentioned object, there is provided a method of machining a crankshaft mold for manufacturing a crankshaft from the crankshaft mold prepared in a die and including extra material at draft portions thereof, comprising: a preliminary machining step for machining at least any of balance weight portions, journal portions and pin portions of the crankshaft mold; a center hole boring step for boring center holes into the crankshaft mold already machined in the preliminary machining step in accordance with a result of mass balance measurement thereof; and a finish machining step for machining the crankshaft mold to a finished product size of the crankshaft by using the center holes as a reference.

According to a still further aspect of the present invention to accomplish the above-mentioned object, there is provided a method of manufacturing a half-finished crankshaft from a crankshaft mold in a process for manufacturing a crankshaft by making the half-finished crankshaft having center holes at opposite end surfaces thereof from a crankshaft mold prepared by casting or forging and including extra material at draft portions thereof and finish machining the half-finished crankshaft up to a finished or nearly finished product size of the crankshaft by using the center holes as a reference, comprising: a preliminary machining step for machining at least any of balance weight portions, journal portions and pin portions of the crankshaft mold.

The method of manufacturing a half-finished crankshaft may include a step of measuring the mass balance of the treated crankshaft mold and boring center holes into its opposite end surfaces after the preliminary machining step.

The method of manufacturing a crankshaft according to the invention includes the preliminary machining step (S2) interposed before primary mass balance measurement (S3) for the subsequent boring or drilling of center holes into opposite end surfaces of the crankshaft mold (S4) as shown in FIG. 1. The preliminary machining (S2) is carried out typically for reducing or fully removing draft portions (already explained and designated by numeral 11 in FIG. 11), or for reducing the amount of correction (amount of unbalance) by mass balance adjustment (S6) in a final stage of the crankshaft manufacturing process. In this sense, any sites of the crankshaft mold including draft portions, which are effective for reducing the amount of unbalance measured by mass balance measurement and therefore reducing the amount of mass balance correction (S6) in a final stage of the manufacturing process, may be selected as targets of the preliminary machining (S2). In other words, for the purpose of reducing the amount of unbalance, any sites of the crankshaft mold meeting this purpose can be the target of preliminary machining (S2), not limited to the sites to be finish machined in the step S5, using the center holes as a reference, namely, as a rotation center. Typically, however, those sites to be finish machined in the step S5 using the center holes as the rotation center are preferably subjected to the preliminary machining (S2). Those sites to be finish machined in the step S5 using the center holes as a rotation center, preferably include opposite side surfaces of balance weight portions of the crankshaft mold, outer circumferences of the balance weight portions, pin portions and journal portions. Among them, balance weight portions are usually very effective portions for reducing the load to subsequent mass balance adjustment.

Insertion of the preliminary machining step (S2) prior to the mass balance measurement of the treated crankshaft mold and the boring of center holes contributes to determining more adequate positions of the center holes. As a result, errors of the crankshaft mold as forged or cast (S1) impose less labor to later mass balance adjustment (S6) after the final finish machining (S5) as compared with the existing method. In addition, errors of the crankshaft mold as forged or cast (S1) impose less labor to the finish machining step (S5) as well. Therefore, the significance of seeking more production accuracy of the crankshaft mold as forged or cast by forging or casting dies is diluted. This permits manufacturers of crankshaft molds to save their efforts for maintenance of the casting or forging dies, and allows even freer designs of casting or forging dies. That is, any draft angles more desirable for facilitating formation and separation of crankshaft molds from the dies are acceptable. Furthermore, it is also possible to omit one or both of the coining step S13 and the shot blasting step S16 described in the explanation of the existing manufacturing process. Thereby, the cost required for manufacturing and preparing treated crankshaft molds, i.e. ready-to-machine crankshaft stocks, can be reduced.

In addition to the above-mentioned advantages, since the method according to the present invention enables more adequate center holes, it makes the control of finish machining (S5) easier and makes it possible to comply with strict requirements of production accuracy of crankshafts. Further, as a side advantage, since the amount to be corrected in the mass balance adjustment of the crankshaft is reduced, the number of balance adjustment cavities to be made in the balance weight portions of the crankshaft as well as the workload for mass balance adjustment can be reduced.

In process sharing or specialization in the manufacturing of crankshafts, a mold manufacturer specialized in casting or forging may ship crankshaft molds as cast or forged in the step S1 to a firm specialized in machining without machined at all, or may ship treated crankshaft molds to the machining specialized firm after preliminary machining (S2) by the mold manufacturer itself. Alternatively, the mold manufacturer may finish even the step of boring or drilling center holes as shown in FIG. 4 in its own factory and may ship half-finished crankshafts already having center holes and ready to finish to the machining factory. Concerning balance adjustment of crankshafts may be done in the machining firm (as shown in FIGS. 2 and 4), or may be done in an automobile manufacturer or an engine manufacturer (as shown in FIGS. 3 and 5).

Other objectives and advantages of the present invention will become apparent from the following detailed description, the accompanying drawings, and the appended claims.

### BRIEF DESCRIPTION OF THE DRAWINGS

FIG. 1 is a diagram for explanation of a basic concept of the present invention.

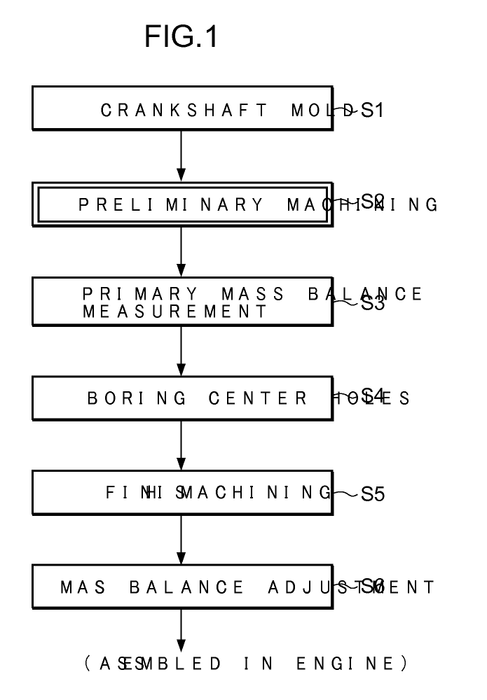

FIG. 2 is a diagram for explanation of an example of process sharing or specialization for carrying out the invention.

FIG. 3 is a diagram for explanation of a further example of process sharing or specialization for carrying out the present invention.

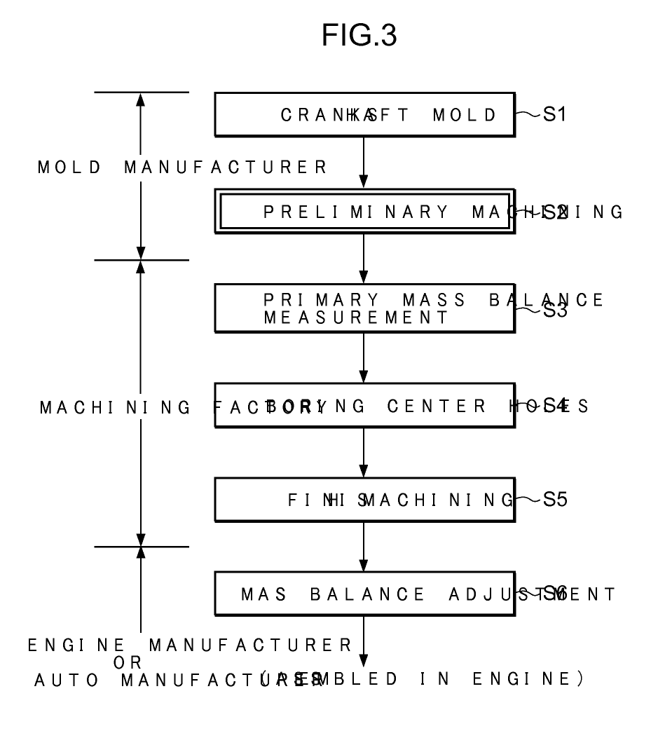

FIG. 4 is a diagram for explanation of a still further example of process sharing or specialization for carrying out the present invention.

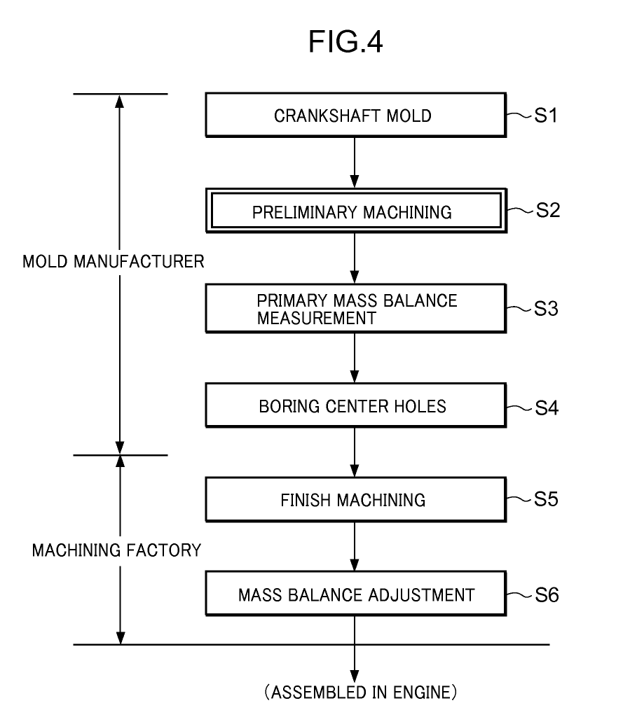

FIG. 5 is a diagram for explanation of a yet further example of process sharing or specialization for carrying out the present invention.

FIG. 6 is a flowchart of a first embodiment.

FIG. 7 is a flowchart of a second embodiment.

FIG. 8 is a flow chart for detailed explanation of a preliminary machining process.

FIG. 9 is a flowchart of an existing manufacturing process of crankshafts.

FIG. 10 is a side elevational view, partly cross-sectioned at opposite end portions of a crankshaft.

FIG. 11 is a diagram for explanation of draft portions included in a crankshaft mold.

### DETAILED DESCRIPTION OF THE INVENTION

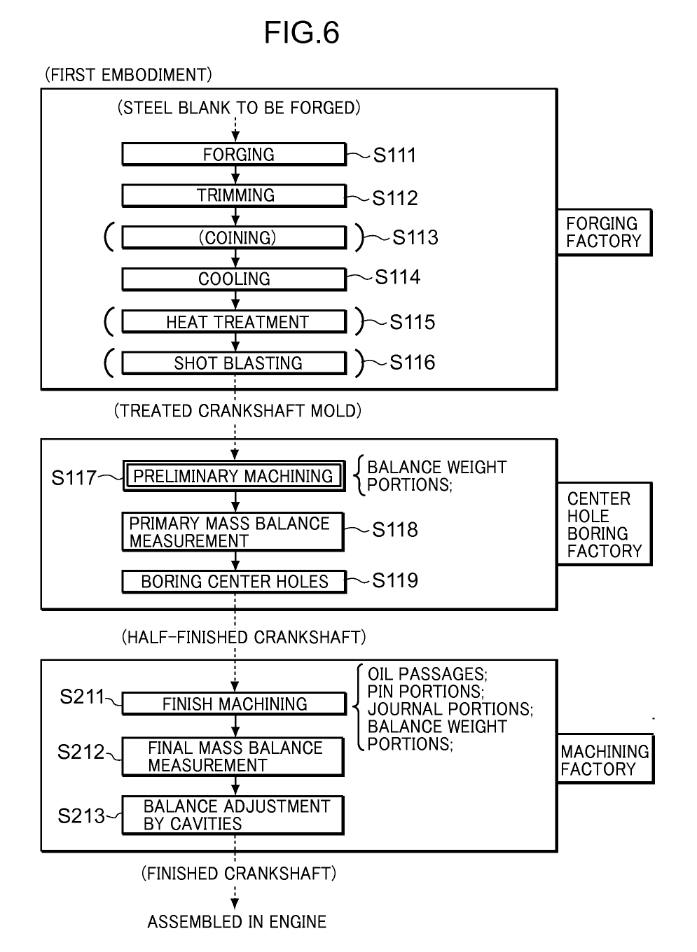

Preferred embodiments of the present invention will be described below with reference to the attached drawings. FIG. 6 is a flowchart showing a series of steps for manufacturing a forged crankshaft according to a first embodiment of the invention.

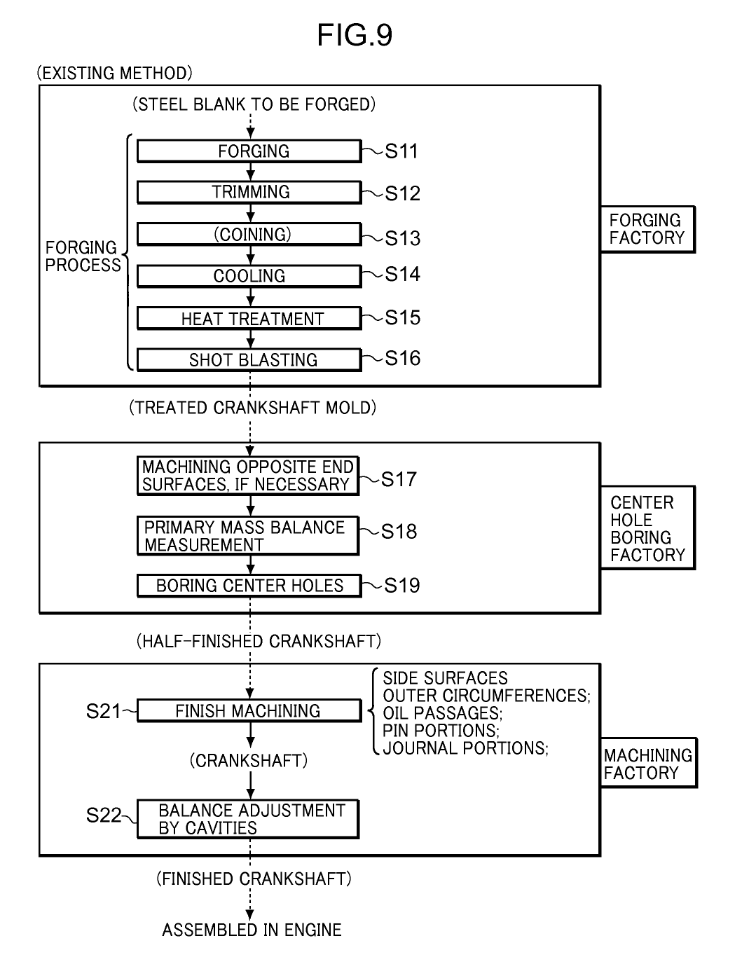

Steps S111 to S119 shown in FIG. 6 make up a process for preparing a half-finished crankshaft from a crankshaft blank. The process for preparing a half-finished crankshaft is carried out in a factory for manufacturing crankshaft molds (hereafter called a mold manufacturing factory as well). As apparent from comparison with FIG. 9 showing an existing manufacturing process, the embodiment of the present invention includes a preliminary machining step S117 interposed before primary mass balance measurement S118. In the preliminary machining step S117, a treated crankshaft mold, which is a ready-to-machine crankshaft stock, is subjected to machining at its balance weight portions. Balance weight portions of the treated crankshaft mold are typical examples of portions to be machined away in the preliminary machining step S117. However, other portions or locations (pin portions, journal portions and other portions not machined in existing methods) can be the target of the preliminary machining as well.

In the preliminary machining step S117, any sites of the balance weight portions other than side surfaces and outer circumferences thereof, which were machined in the existing manufacturing process as well, may be selected to machine. It is also acceptable to limit the target of the preliminary machining S117 to locations effective for reducing the labor of mass balance adjustment (for example, locations on side surfaces of the balance weight portions nearer to their outer circumferential ends). Further, opposite ends of the shaft portion of the crankshaft mold may be added as the target of the preliminary machining S117.

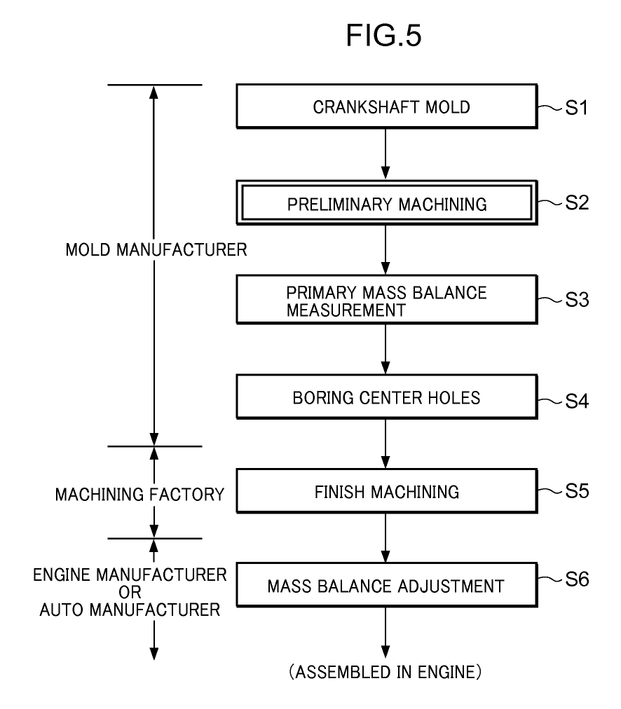

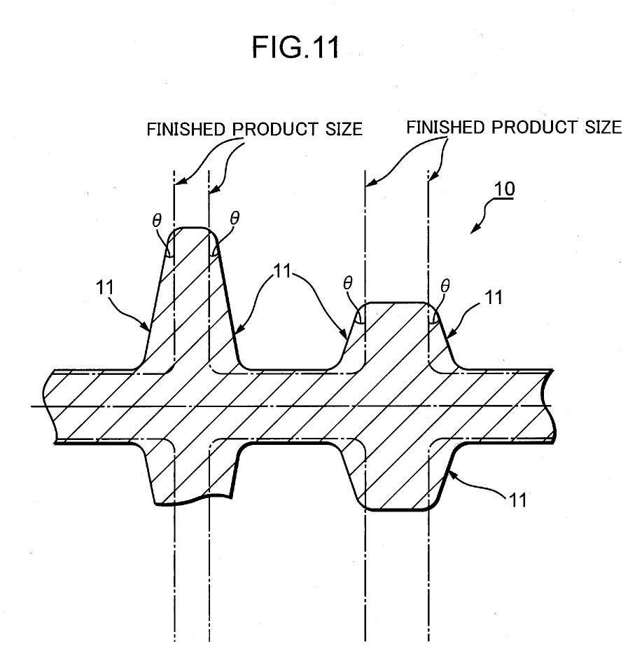

For example, in case the side surfaces and the outer circumferences of the balance weight portions 6 are machined in the preliminary machining step S117, they may be machined up to a finished or nearly finished product size of the crankshaft. As a result of the preliminary machining S117, extra material at draft portions 11 (see FIG. 11) can be machined away from opposite side surfaces of the balance weight portions 6 of the crankshaft mold. If machined up to the finished product size of the crankshaft in this step, no further machining is needed on the opposite sides of the balance weight portions in the finish machining step S211 of FIG. 5, explained later.

With reference to FIG. 6, the manufacturing process of crankshafts is explained below. In the forging step S111, a crankshaft mold as forged is made by hot forging using a press forging machine or a hammer forging machine in the same manner as the existing method. After that, the crankshaft mold as forged is normally subjected to trimming (S112), coining (S113) and cooling (S114) and, if necessary, heat treatment (S115). After next shot blasting (S116), a treated crankshaft mold is obtained. The series of these steps S111 to S116 is carried out in a forging factory. Among these steps, the coining (S113) and shot blasting (S116) steps are optional, and one or both of these steps may be omitted.

The treated crankshaft mold is delivered to a center hole boring or drilling factory and subjected to the preliminary machining step S117 explained above. After that, in the same manner as the existing method, center holes are bored or drilled (S119) in accordance with a result of primary mass balance measurement (S118). Thus, a half-finished crankshaft having center holes is obtained and shipped from the center hole boring factory to a machining factory (finish machining factory).

The series of steps of machining carried out on the half-finished crankshaft is the same as that of the existing method. Namely, the half-finished crankshaft is machined (finish machined) up to the finished product size of the crankshaft, using the center holes as a rotation center (S211). This finish machining in step S211 includes machining of outer circumferences of the balance weight portions 6, machining and polishing of the pin portions 5, machining and polishing of the journal portions 3, boring or drilling of oil passages 7, and others. In case the machining of opposite side surfaces of the balance weight portions 6 in the preliminary machining process S117 is limited to partial machining, the side surfaces of the balance weight portions 6 are machined to the finished product size of the crankshaft in the finish machining step S211.

The crankshaft 1 is then subjected to final mass balance adjustment to remove the measured amount of unbalance (S213). The final mass balance adjustment in step S213 is achieved by locally reducing the weight of the balance weight portions 6. More specifically, like the existing method, balance adjusting cavities 7 are drilled or excavated into the outer circumferential surfaces of the balance weight portions 6 to adjust the mass balance of the crankshaft.

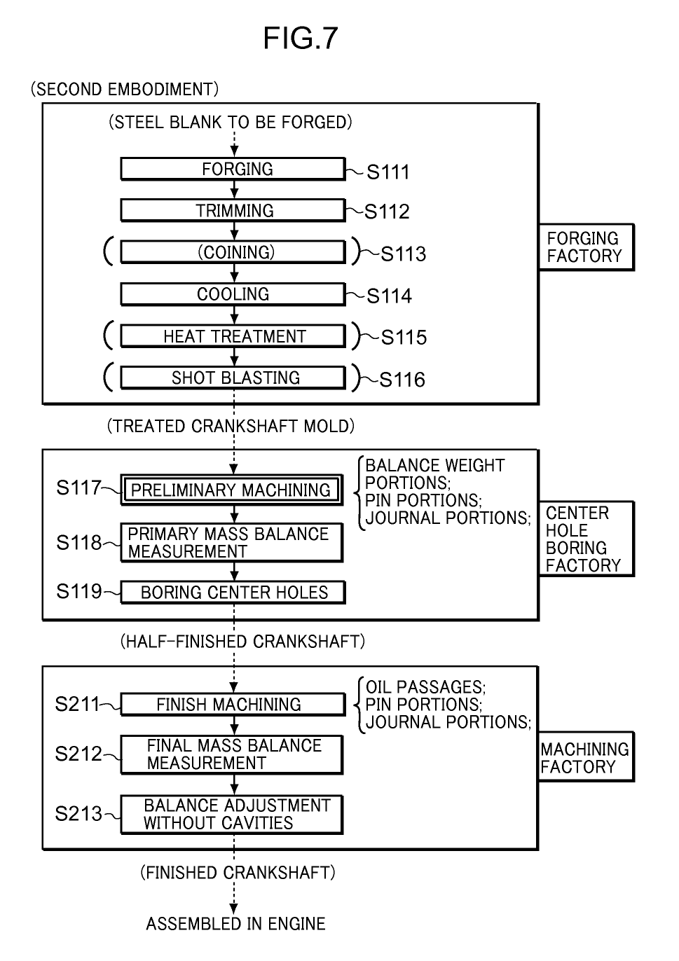

FIG. 7 shows a second embodiment. It will be understood by comparing FIG. 7 with FIG. 6, the flow of FIG. 7 is the same as the flow of the first embodiment (FIG. 6) explained above. Therefore, the same reference numerals as used in FIG. 6 are used in FIG. 7 as well to denote the corresponding steps.

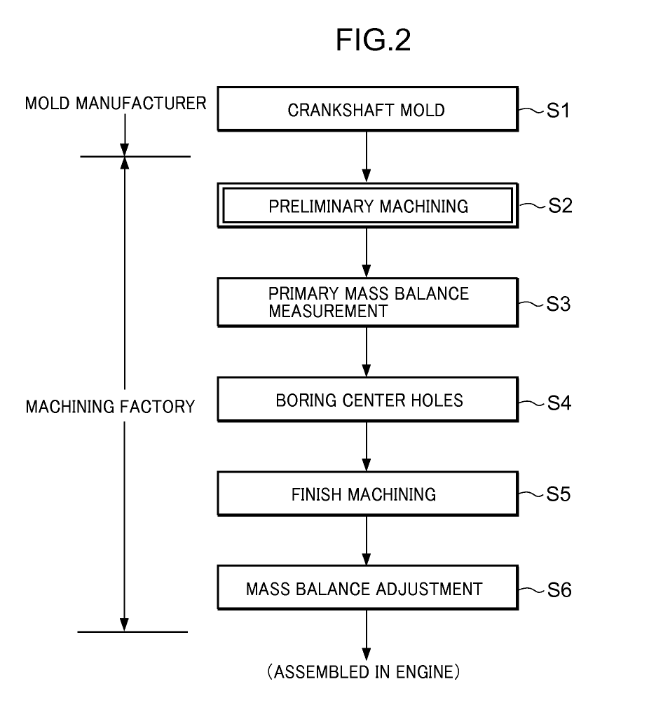

Difference between the first embodiment and the second embodiment lies in contents of tasks included in the preliminary machining step S117 carried out in the center hole boring factory. In the preliminary machining step S117, the first embodiment has been explained as machining the balance weight portions 6 of the crankshaft mold. In the second embodiment (FIG. 2), however, the target of the preliminary machining S117 of the crankshaft mold includes machining of opposite surfaces of the balance weight portions 6, machining of outer circumferential surfaces, and machining of journal portions 3 and the pin portions 5. In the preliminary machining in the second embodiment, outer circumferential surfaces of the balance weight portions 6 may be machined away up to the finished product size of the crankshaft. However, preliminary machining of the journal portions 3 and the pin portions 5 had better be limited to a size larger than the finished product size by 1 mm to leave a slight amount of extra material there for later finish machining or polishing.

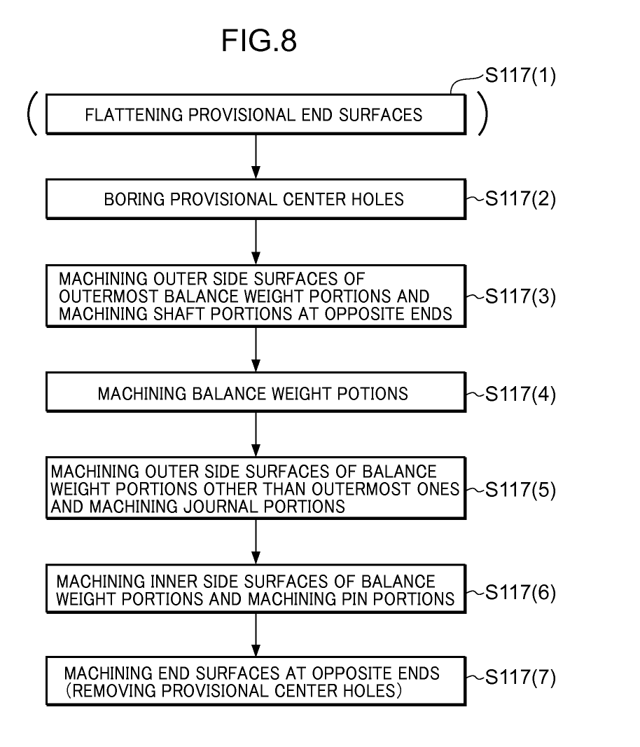

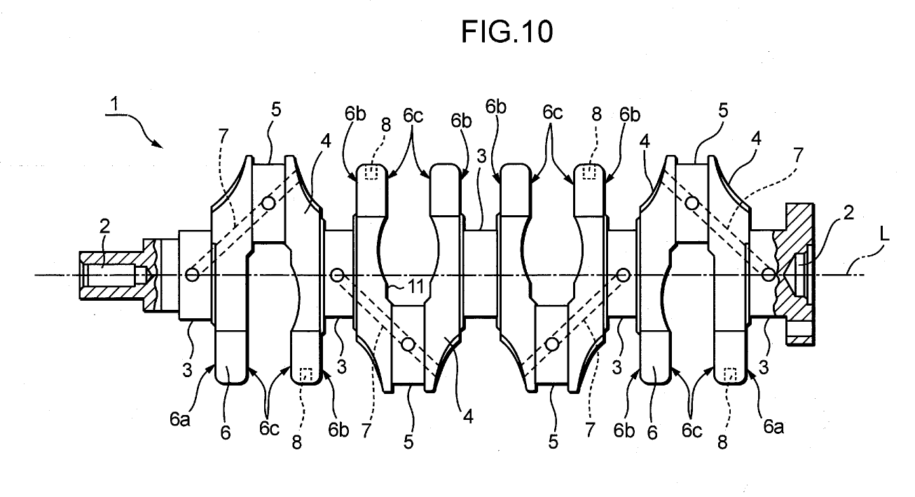

FIG. 8 is a flow chart roughly showing the process of the preliminary machining step S117. As shown in FIG. 8, the preliminary machining S117 first machines the opposite end surfaces of the crankshaft mold flat and makes flat provisional end surfaces (S117(1)). However, this step S117(1) of making the provisional end surfaces is optional and may be omitted. After that, provisional center holes are bored into the provisional end surfaces (S117(2)). Thereafter, while holding the crankshaft mold by using the provisional center holes, machining is carried out on outer circumferential surfaces 6a (FIG. 10) of balance weight portions at outermost positions (S117(3)), next on shaft portions at the opposite axial ends (S117(3)), and next on outer circumferential portions of the balance weight portions (S117(4)).

Subsequently, while rotating the crankshaft mold by using the provisional holes as the rotational axis, machining is carried out on outer side surfaces 6b (FIG. 10) of respective balance weight portions other than the outermost balance weight portions of the crankshaft mold and on journal portions 3 (S117(5)). Further, machining is continued on inner side surfaces 6c (FIG. 10) of the balance weight portions and on pin portions 5 that are eccentric axes (S117(6)). As a result, the crankshaft mold is machined up to an outer contour near to the size of the finished crankshaft 1. After that, the provisional center holes are removed by machining the opposite end surfaces (S117(7)). The order of these steps S117(2) through S117(6) may be changed, and any one or more of the steps may be omitted here to do in the finish machining step S211 in a later stage. Once the series of sub steps of the preliminary machining step S117 is completed, the flow moves to the next primary mass balance measurement (S118), and center holes are bored into opposite end surfaces of the crankshaft mold (S119) like the existing method.

It will be understood from explanation of the first embodiment (FIG. 6) and the second embodiment (FIG. 7) that the preliminary machining S117 inserted before the primary mass balance measurement S118 carried out for subsequent boring of center holes as a reference of final machining makes it possible to determine more appropriate positions of the center holes to be made in the crankshaft mold. The task of the later finish machining step S211 is therefore alleviated. Moreover, also because a considerable amount of extra material of the crankshaft mold is already removed by the preliminary machining S117, the amount of extra material to be machined away in the finish machining step S211 is reduced. In other words, since the preliminary machining S211 can reduce the load to the final machining S211 irrespectively of the production accuracy of the crankshaft mold as forged or cast, mold manufacturers' care required for maintenance of dies for forging or casting crankshaft molds are alleviated. At the same time, since the amount of extra material placed at the draft portions 11 (FIG. 11) do not impose extra labor for removal to finish machining S211, freer designs of draft angles are acceptable, and dies can be designed more freely to make forging or casting easier. For example, when manufacturing a crankshaft mold by a hammer forging machine, the die used in combination can be designed to have a larger draft angle at the draft portions 11 for easier forging. Furthermore, the preliminary machining S117 alleviates the labor of balance adjustment S213 as well. This makes it easier to satisfy even stricter production accuracy of crankshafts. In addition, the center holes bored at more appropriate positions contribute to reducing the amount of adjustment in the mass balance adjustment step S213.

Further, although optional, since the coining step (S13 of FIG. 9) and/or the shot blast step (S16 of FIG. 9) included in the existing method can be omitted, the invention can reduce the cost for manufacturing half-finished crankshafts.

Especially in the second embodiment (FIG. 7), the preliminary machining S117 prior to primary mass balance measurement S118 may be executed on the balance weight portions, pin portions and journal portions to provide half-machined and ready-to-finish crankshaft such that the later finish machining S211 may execute substantially only precision machining to finish the pin portions and the journal portions. Therefore, more adequacy is expected in determining positions of the center holes bored into the crankshaft mold. Therefore, roughness, if any, in the crankshaft mold as forged or cast does not adversely affect the finish machining S211, and maintenance of dies used for forging or casting the crankshaft mold is still easier. At the same time, since the finish machining S211 is free from the production accuracy and the volume of the extra material in the draft portions 11 (FIG. 11) of the crankshaft mold, dies for casting or forging crankshaft molds can be designed from various standpoints including ductility, easier separation of molds from dies, durability of dies themselves, and others.

Heretofore, the invention has been explained by way of first and second embodiments as manufacturing a forged crankshaft, it will be apparent that the invention is applicable to cast crankshafts as well.

What is claimed is:

1. A method of manufacturing a crankshaft comprising:
a forming step for preparing a crankshaft mold in a die;
a machining step for obtaining a crankshaft by machining the crankshaft mold to a finished product size of the crankshaft; and
a mass balance adjustment step for adjusting the mass balance of the crankshaft,
wherein the machining step includes:
a preliminary machining step for machining side surfaces of balance weight portions of the crankshaft mold;
a center hole boring step for boring center holes into the crankshaft mold already machined in the preliminary machining step in accordance with a result of mass balance measurement; and
a finish machining step for finish machining the crankshaft mold to the finished product size thereof and obtaining the crankshaft by using the center holes as a reference,
wherein machining of the preliminary machining step applied to the side surfaces of the balance weight portions is executed up to a finish product size or nearly finished product size of the crankshaft.

2. The method according to claim 1 wherein the preliminary machining step also machines outer circumferences of the balance weight portions in addition to their side surfaces.

3. The method according to claim 1 wherein the preliminary machining step additionally machines pin portions and/or journal portions of the crankshaft mold as well.

4. The method according to claim 2 wherein the preliminary machining step additionally machines pin portions and/or journal portions of the crankshaft mold as well.

5. The method according to claim 1 wherein the preliminary machining step machines extra material at draft portions on the side surfaces of the balance weigh portions of the crankshaft mold.

6. The method according to claim 2 wherein the preliminary machining step machines extra material at draft portions on the side surfaces of the balance weigh portions of the crankshaft mold.

7. The method according to claim 1 wherein the side surfaces of the balance weight portions of the crankshaft mold machined in the preliminary machining step include inner and/or outer side surfaces of the balance weight portions.

8. The method according to claim 2 wherein the side surfaces of the balance weight portions of the crankshaft mold machined in the preliminary machining step include inner and/or outer side surfaces of the balance weight portions.

9. The method according to claim 2 wherein the outer circumferences of the balance weight portions are machined to a finished or nearly finished product size of the crankshaft in the preliminary machining step.

10. The method according to claim 6 wherein the crankshaft mold is prepared by using a hammer forging machine.

11. A method of manufacturing a crankshaft by measuring mass balance of a crankshaft mold formed in a die and including extra material at draft portions and boring center holes into the crankshaft mold, next machining the crankshaft mold into a crankshaft, and thereafter adjusting the mass balance of the crankshaft, comprising:
a preliminary machining step for machining the crankshaft mold before measuring the mass balance of the crankshaft mold and boring center holes into the crankshaft mold,
wherein the preliminary machining step includes:
a step for boring provisional center holes into opposite end surfaces of the crankshaft mold;
a step of machining opposite end portions of the crankshaft mold supported at the provisional center holes;
a step of machining side surfaces and outer circumferences of balance weight portions of the crankshaft mold supported at the provisional center holes; and
a step of removing the provisional center holes by machining the opposite end surfaces of the crankshaft mold, and
wherein at least the extra material at the draft portions on the side surfaces of the crankshaft is subjected to machining in the preliminary machining step, and the side surfaces and the outer circumferences of the balance weight portions of the crankshaft mold are machined to a finished or nearly finished product size of the crankshaft.

12. A method of manufacturing a crankshaft, comprising:
a forming step for preparing a crankshaft mold in a die;
a machining step for obtaining a crankshaft by machining the crankshaft mold to a finished product size thereof; and
a mass balance adjustment step for adjusting the mass balance of the crankshaft,
wherein the machining step includes:
a preliminary machining step for machining side surfaces and outer circumferences of balance weight portions, pin portions and journal portions of the crankshaft mold;
a center hole boring step for boring center holes into the crankshaft mold already machined in the preliminary machining in accordance with a result of the mass balance measurement; and
a finish machining step for obtaining a crankshaft by finish machining the crankshaft mold by using the center holes as a reference, and
wherein machining onto the side surfaces and outer circumferences of the balance weight portions, pin portions and journal portions is effected to shape them into a finished or nearly finished product size of the crankshaft.

13. A method of machining a crankshaft mold for manufacturing a crankshaft from the crankshaft mold prepared in a die and including extra material at draft portions thereof, comprising:
a preliminary machining step for machining side surfaces and outer circumferences of balance weight portions of the crankshaft mold as well as pin portions of the crankshaft mold;
a center hole boring step for boring center holes into the crankshaft mold already machined in the preliminary machining step in accordance with a result of mass balance measurement thereof; and
a finish machining step for machining the crankshaft mold into a finished product size of the crankshaft by using the center holes as a reference,
wherein draft portions on the side surfaces of the balance weight portions of the crankshaft mold are subjected to machining in the preliminary machining step, and the side surfaces of balance weight portions are machined up to a finished or nearly finished product size of the crankshaft in the preliminary machining step.

14. The method according to claim 13 wherein the side surfaces of the balance weight portions of the crankshaft mold machined in the preliminary machining step include inner and/or outer side surfaces of the balance weight portions.

15. The method according to claim 13 wherein the preliminary machining of the outer circumferences of the balance weight portions in the preliminary machining step is executed up to a finished or nearly finished product size of the crankshaft.

16. The method according to claim 14 wherein the preliminary machining of the outer circumferences of the balance weight portions in the preliminary machining step is executed up to a finished or nearly finished product size of the crankshaft.

17. A method of manufacturing a half-finished crankshaft having a finished or nearly finished product size of a crankshaft from a crankshaft mold, in a process for manufacturing the crankshaft, by boring center holes at opposite end surfaces of the crankshaft mold prepared by casting or forging and including extra material at draft portions thereof and subsequently machining the crankshaft mold up to the finished or nearly finished product size of the crankshaft with reference to the center holes, comprising:
a preliminary machining step for machining side surfaces and outer circumferences of balance weight portions as well as pin portions of the crankshaft mold;
wherein at least the extra material at the draft portions on the side surfaces of the crankshaft is subjected to machining in the preliminary machining step, and the side surfaces and the outer circumferences of the balance weight portions are machined up to a finished or nearly finished product size of the crankshaft in the preliminary machining step, and
wherein the preliminary machining step is followed by measuring mass balance of the crankshaft mold and boring the center holes into opposite end surfaces thereof.

18. The method according to claim 13 wherein the preliminary machining step includes:
a step for boring provisional center holes into opposite end surfaces of the crankshaft mold;
a step of machining opposite end portions of the crankshaft mold supported at the provisional center holes;
a step of machining side surfaces and outer circumferences of balance weight portions as well as pin portions of the crankshaft mold supported at the provisional center holes; and
a step of removing the provisional center holes by machining the opposite end surfaces of the crankshaft mold.

19. The method according to claim 17 wherein inner and/or outer side surfaces of the balance weight portions of the crankshaft mold are machined in the preliminary machining step.

20. The method according to claim 17 wherein the crankshaft mold is prepared by using a hammer forging machine.
